(19) United States
(12) Patent Application Publication
(10) Pub. No.: US 2025/0353575 A1
(43) Pub. Date: Nov. 20, 2025

(54) DRIVETRAIN FOR A BICYCLE

(71) Applicant: Specialized Bicycle Components, Inc., Morgan Hill, CA (US)

(72) Inventors: Jeffrey Keith Bowers, Bellingham, WA (US); John Charles Doherty, Capitola, CA (US); Brian Daniel Robinson, Morgan Hill, CA (US)

(21) Appl. No.: 19/208,122

(22) Filed: May 14, 2025

Related U.S. Application Data
(60) Provisional application No. 63/649,121, filed on May 17, 2024.

(51) Int. Cl. B62M 9/04; B62M 6/70

(52) U.S. Cl. CPC B62M 9/04; B62M 6/70

(57) ABSTRACT

A drivetrain for a bicycle includes a spindle, a chain forming a closed loop and having an inner periphery and an outer periphery, and an idler rotatable around the spindle. The idler is engaged with the outer periphery of the chain.

### CROSS-REFERENCE TO RELATED APPLICATIONS

This application claims priority to U.S. Provisional Patent Application No. 63/649,121, filed May 17, 2024, the entire contents of which are incorporated herein by reference.

### BACKGROUND

The present disclosure relates generally to bicycles, and more specifically to drivetrains for bicycles.

Typically, bicycles are propelled mechanically by pedals, which are coupled to an overall drivetrain on the bicycle. The drivetrain transfers energy exerted on the pedals by a rider to advance the bicycle. The drivetrain typically includes one or more sprockets that engage a chain to transfer the energy to a rear wheel.

Electric bicycles, typically referred to as “e-bikes,” commonly include electrical components, such as battery-operated electric motors, power supplies, controllers, data displays, and/or brake lever switches, etc., which are electromechanically operated during use. In some electric bicycles, an electric motor may be operated to provide energy to the drivetrain (e.g., to be transferred to the rear wheel), to propel the electric bicycle. In some electric bicycles, the electric motor may be operated to supplement mechanical and user applied input power from the pedals to propel the electric bicycle.

### BRIEF DESCRIPTION OF THE DRAWINGS

FIG. 1 is a side view of a bicycle according to one example.

FIG. 2 is an enlarged view of a portion of a drivetrain of the bicycle of FIG. 1 with a crank arm removed.

FIG. 3 illustrates a portion of the drivetrain, with a crank arm, a cover of a bottom bracket, and a primary chain removed.

FIG. 4 is a perspective view of a portion of the drivetrain.

FIG. 5 is a perspective view of a drive gear of the geartrain, coupled to a spindle.

FIG. 6 is a perspective view of an idler of the drivetrain, coupled to the spindle.

FIG. 7 is a perspective view of a main gear of the drivetrain coupled to a secondary shaft.

FIG. 8 is a perspective view of a first driven gear of the drivetrain, coupled to the secondary shaft.

FIG. 9 is a top view of the drivetrain.

FIG. 10 is a schematic illustration of the overall drivetrain.

### DETAILED DESCRIPTION

Before any examples are explained in detail, it is to be understood that the disclosure is not limited in its application to the details of construction and the arrangement of components set forth in the following description or illustrated in the following drawings. The disclosure is capable of other examples and of being practiced or of being carried out in various ways.

In one example, the present disclosure provides a drivetrain for a bicycle. The drivetrain includes a spindle, a chain forming a closed loop and having an inner periphery and an outer periphery, and an idler rotatable around the spindle. The idler is engaged with the outer periphery of the chain.

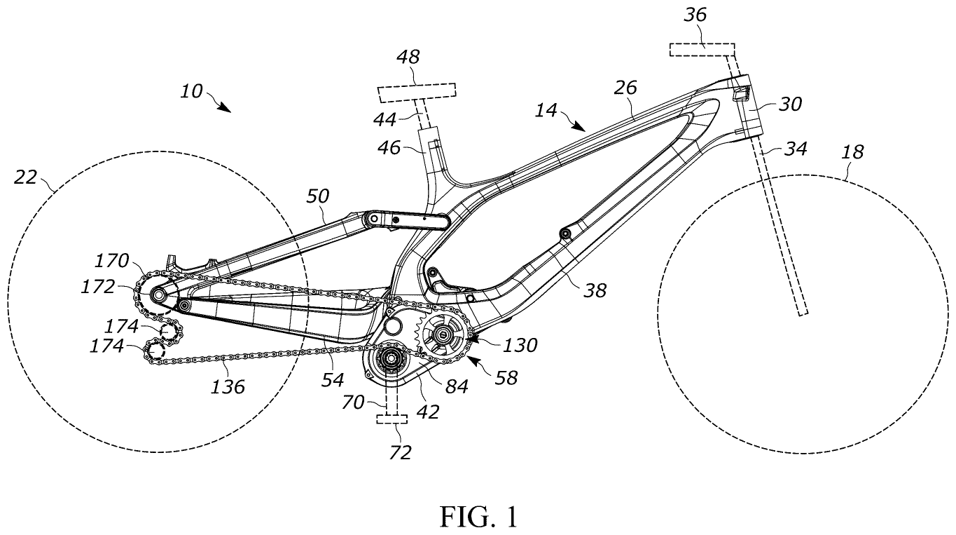

FIGS. 1-10 illustrate a bicycle 10. As illustrated in FIG. 1, the bicycle 10 includes a frame 14. A front wheel 18 (illustrated schematically) is coupled to the frame 14, and a rear wheel 22 (illustrated schematically) is also coupled to the frame 14. The front wheel 18 and the rear wheel 22 each support the frame 14.

In many examples, the frame 14 and/or the bicycle 10 overall may include a top tube 26, a head tube 30, a front fork 34 (illustrated schematically), handlebars 36 (illustrated schematically), a downtube 38, a bottom bracket 42, a seat post 44 (illustrated schematically), a seat tube 46, a seat 48 (illustrated schematically), a seatstay (or set of seatstays) 50, and/or a chainstay (or set of chainstays) 54. Further, the front wheel 18 can be coupled to the front fork 34, and the rear wheel 22 can be coupled to the seatstays 50 and/or the chainstays 54. In some examples, the frame 14 may include a main frame and a rear frame. For example, the main frame may include the top tube 26, the downtube 38, the bottom bracket 42, and the seat tube 46, and the rear frame may include the seatstays 50 and the chainstays 54. In further examples, the rear frame may move (e.g., pivot) relative to the main frame. In these or other examples, the bicycle 10 also may include one or more suspension components (e.g., shock absorbers) that absorb energy and movement of the components of the frame 14. For example, the bicycle 10 may include a suspension component (e.g., shock absorber) coupled between the main frame and the rear frame to absorb energy and movement of the rear frame relative to the main frame. Further, the bicycle 10 also may include one or more linkages between the seatstays 50 and/or the chainstays 54) and the main frame. For example, the bicycle 10 may include a linkage between the seatstays 50 and the seat tube 46, and/or one or more (e.g., two) linkages between the chainstays 54 and a suspension component (e.g., shock absorber) coupled to the downtube 38. In other examples, the frame 14 may include other numbers, types, and/or arrangements of frame components than that illustrated. The bicycle 10 overall may be any type of bicycle configured to incorporate a drivetrain that is coupled to a frame of the bicycle 10 (e.g., the frame 14) and configured to propel the bicycle 10 along a direction of travel (e.g., forward), including for example a bicycle that is propelled solely by mechanical input through pedals, or an electric bicycle that provides some or all of the energy needed to propel the bicycle. Accordingly, while not illustrated, in some examples the bicycle 10 may include a battery positioned within or otherwise integrated with the frame 14, and may also include a motor (e.g., coupled to the bottom bracket 42) coupled to the battery.

With continued reference to FIGS. 1-10, the bicycle 10 includes a drivetrain 58 coupled to the frame 14 for propelling the bicycle 10 along a direction of travel (e.g., forward). In the illustrated example, a portion of the drivetrain 58 is coupled to the bottom bracket 42, although in other examples the drivetrain 58 may not be coupled to the bottom bracket 42, and instead may be coupled to another portion of the frame 14.

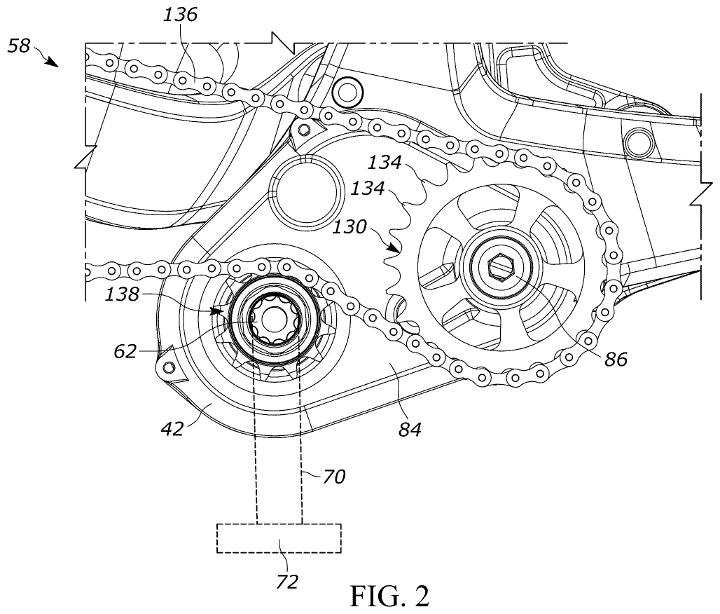

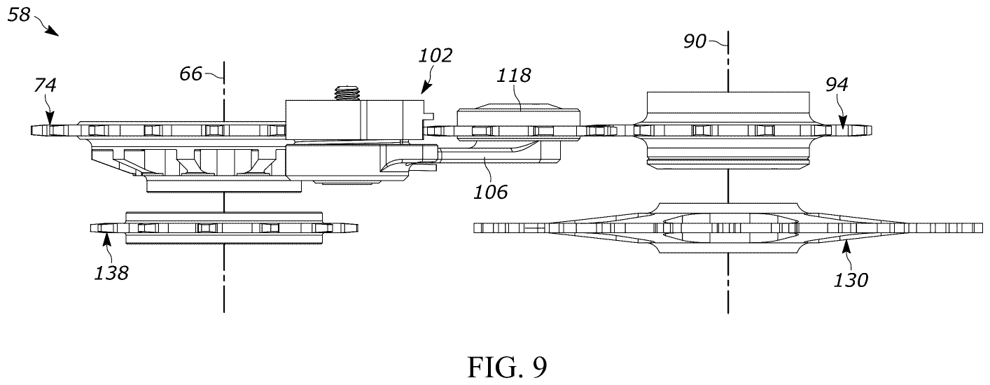

With reference to FIGS. 2-6, the drivetrain 58 may include a spindle 62. In the illustrated example, the spindle 62 is a bottom bracket spindle 62. The spindle 62 is rotatable about a spindle axis 66 (FIG. 9). The spindle 62 may be coupled to and extend through the bottom bracket 42 and may rotate relative to the bottom bracket 42 (e.g., with the use of a bearing or bearings located within the bottom bracket 42). In the illustrated example, a portion of the spindle 62 extends axially outwardly from the bottom bracket 42 on both sides of the frame. In other examples, the spindle 62 may be coupled to a different portion of the frame 14 (e.g., if the bicycle 10 does not include a bottom bracket 42).

The drivetrain 58 also may include a crank arm or arms 70 (illustrated schematically in FIGS. 1 and 2) and a pedal or pedals 72 (illustrated schematically in FIGS. 1, 2, and 10). The crank arms 70 can be secured at first ends to different, opposite ends of the spindle 62 and at second ends to the pedals 72 to facilitate rotation of the spindle 62 about the spindle axis 66. When the rider applies force to the pedals 72, the spindle 62 rotates about the spindle axis 66. In other examples, the drivetrain 58 does not include a crank arm or arms 70 and a pedal or pedals 72, such as with an e-bike driven purely by an electric motor.

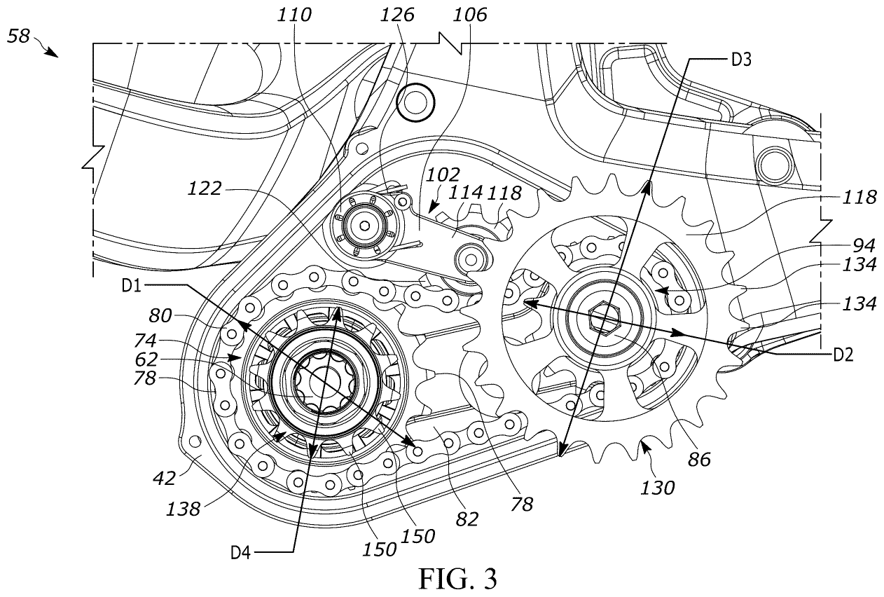

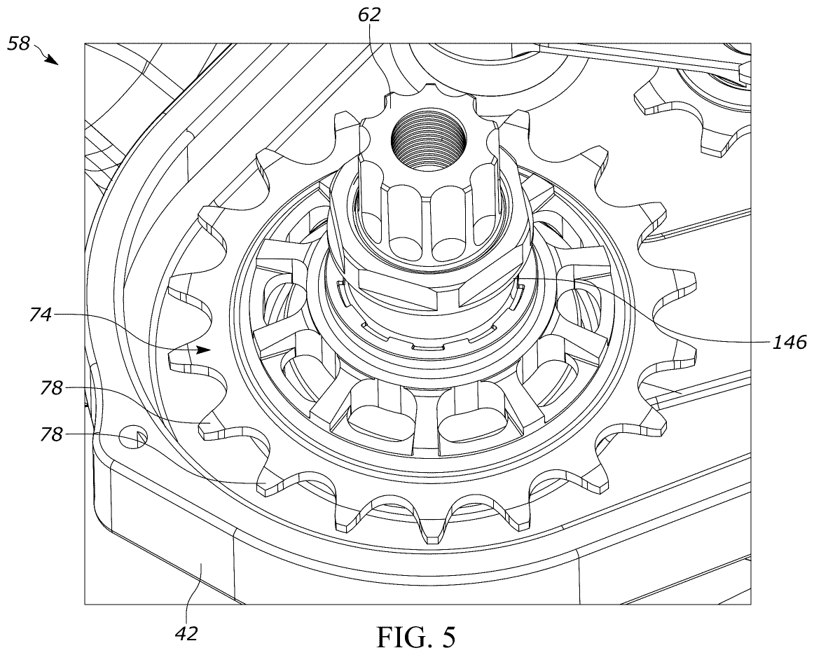

With reference to FIGS. 3-5 and 9, the drivetrain 58 also may include a drive gear 74 coupled (e.g., releasably coupled or fixed) to the spindle 62, such that the drive gear 74 will rotate with the spindle 62 as the crank arms 70 are rotated by application of force to the pedals 72. As illustrated in FIG. 5, in some examples the drive gear 74 may be coupled to the spindle 62 with a splined connection. Other examples include other ways of coupling the drive gear 74 to the spindle 62 (e.g., with fasteners, clamps, etc.). In some examples, the drive gear 74 is integrally formed as a single piece with the spindle 62.

The drive gear 74 may include teeth 78 that project radially outwardly. As illustrated in FIG. 3, the drive gear 74 may have an overall outer diameter D1, defined by the teeth 78. While a particular number and shape of teeth 78 are illustrated in the figures, the drive gear 74 may have other numbers and/or shapes of teeth 78 than those illustrated. Additionally, the drive gear 74 may have a diameter D1 other than that illustrated.

With reference to FIG. 3, in some examples the drive gear 74 may be positioned at least partially within an interior cavity 82 of the bottom bracket 42 and may be partially or entirely enclosed within the interior cavity 82 and hidden from view from outside of the bicycle 10 by a cover 84 (the cover 84 is shown in FIGS. 1 and 2 but is removed in FIG. 3). In other examples, at least a portion of the drive gear 74 may be visible and positioned outside of the interior cavity 82.

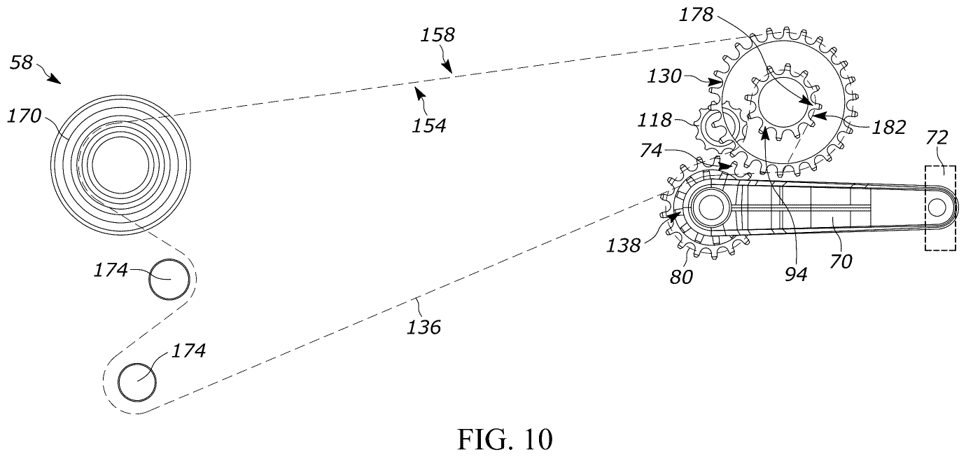

As illustrated in FIGS. 3 and 10, and as described in further detail below, the drive gear 74 may drive a secondary chain 80. For example, the secondary chain 80 may be a roller chain configured to interface with the drive gear 74 and/or a first driven gear 94 as described in further detail below. In other embodiments, the secondary chain 80 can be implemented as a belt rather than a chain.

With reference to FIGS. 2-4, 7, and 8, the drivetrain 58 may include a secondary shaft 86 (e.g., a jackshaft, thru-shaft, overdrive spindle, and/or other type of shaft). In the illustrated example, the secondary shaft 86 is rotatable about a secondary shaft axis 90 (FIG. 9). The secondary shaft axis 90 may be parallel to the spindle axis 66, although in other examples the secondary shaft axis 90 may not be parallel to the spindle axis 66. The secondary shaft 86 may be coupled to and extend through the bottom bracket 42 and may rotate relative to the bottom bracket 42 (e.g., with the use of a bearing or bearings located within the bottom bracket 42). In the illustrated example, a portion of the secondary shaft 86 extends axially outwardly from the bottom bracket 42. In other examples, the secondary shaft 86 may be coupled to a different portion of the frame 14 (e.g., if the bicycle 10 does not include a bottom bracket 42).

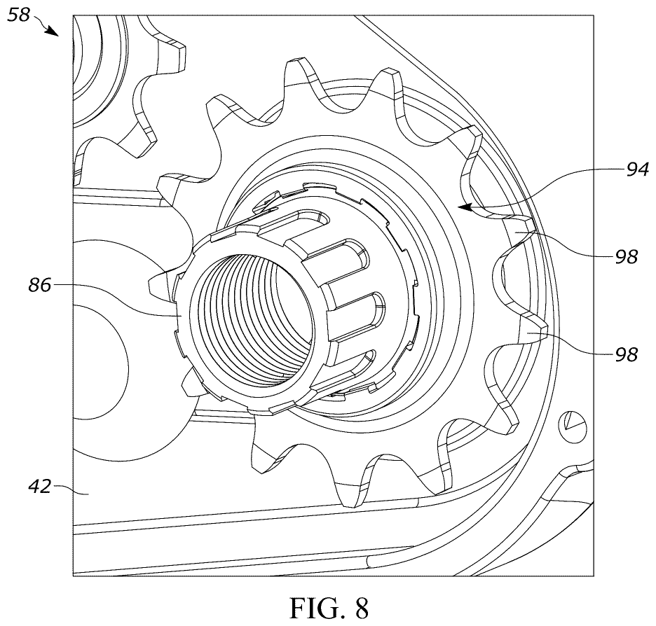

With reference to FIGS. 3, 4, and 7-9, the drivetrain 58 may include a first driven gear 94 coupled (e.g., releasably coupled or fixed) to the secondary shaft 86, such that the first driven gear 94 rotates with the secondary shaft 86. As described further herein, the first driven gear 94 is driven by the drive gear 74 via the secondary chain 80. As illustrated in FIG. 8, the first driven gear 94 may be coupled to the secondary shaft 86 with a splined connection. As such, rotation of the first driven gear 94 will cause rotation of the secondary shaft 86. Other examples include other ways of coupling the first driven gear 94 to the secondary shaft 86 (e.g., with fasteners, clamps, etc.). In some examples, the first driven gear 94 is integrally formed as a single piece with the secondary shaft 86.

The first driven gear 94 may include teeth 98 that project radially outwardly. As illustrated in FIG. 3, the first driven gear 94 may have an overall outer diameter D2. While a particular number and shape of teeth 98 are illustrated in the figures, the first driven gear 94 may have other numbers and/or shapes of teeth 98 than those illustrated. Additionally, the first driven gear 94 may have a diameter D2 other than that illustrated.

In the illustrated example, the diameter D2 of the first driven gear 94 is smaller than the diameter D1 of the drive gear 74, and the number of teeth 98 on the first driven gear 94 is less than the number of teeth 78 on the drive gear 74.

With reference to FIGS. 2 and 3, in some examples the first driven gear 94 may be positioned within the interior cavity 82, and/or be partially or entirely enclosed within the interior cavity 82. In other examples, at least a portion of the first driven gear 94 may be positioned outside of the interior cavity 82 of the bottom bracket 42 and may be partially or entirely exposed and visible from outside of the bicycle 10.

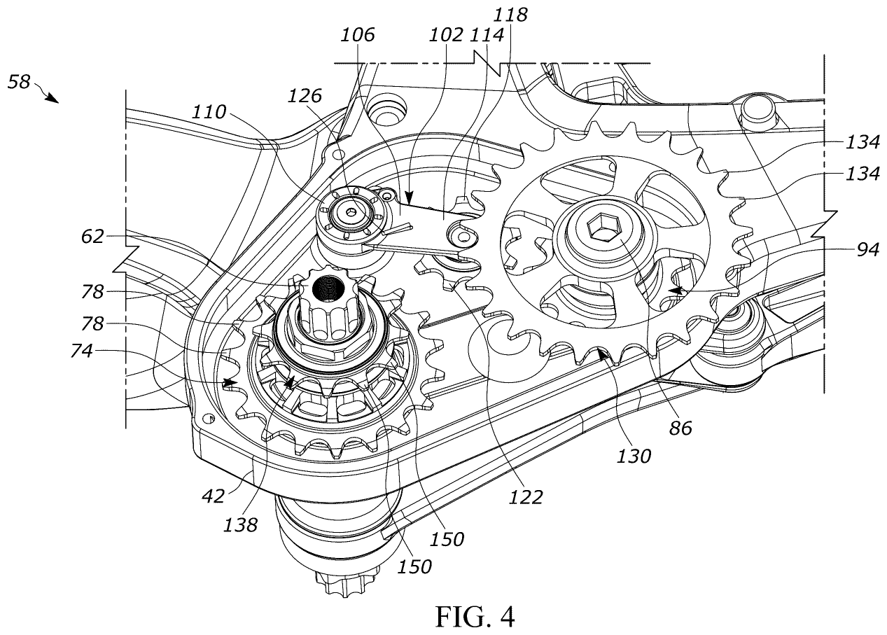

With reference to FIGS. 3, 4, and 9, the drivetrain 58 may include a tensioner 102. The tensioner 102 may be coupled to the bottom bracket 42, or another portion of the frame 14. The tensioner 102 may be positioned partially or entirely within the interior cavity 82 of the bottom bracket 42, and generally between the drive gear 74 and the first driven gear 94. In some examples, the tensioner 102 may include an arm 106 having a first end 110 and a second, opposite end 114. The first end 110 may be rotatably coupled to the bottom bracket 42. A pulley 118 may be coupled (e.g., rotatably coupled) to the second end 114, and the pulley 118 may include teeth 122 that extend radially outwardly. A spring 126 (e.g., torsion spring) may be coupled to the arm 106, and may bias the arm 106 and its attached pulley 118 in one direction (e.g., in a clockwise direction as viewed in FIGS. 3 and 4). In other examples the tensioner 102 is not included, or the tensioner 102 includes other numbers and arrangements of parts than that illustrated, and/or is located in a different position than that illustrated.

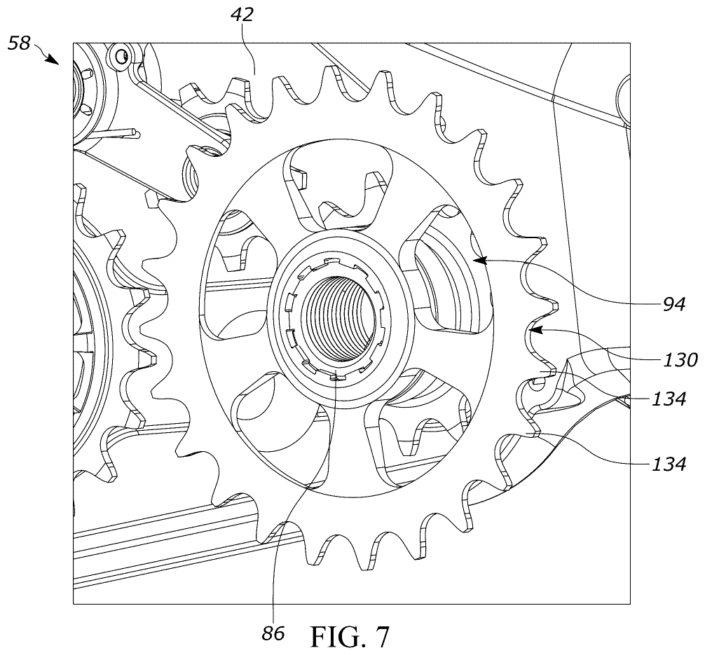

With reference to FIGS. 2-4, 7, and 9, the drivetrain 58 may include a main gear 130 coupled (e.g., releasably coupled or fixed) to the secondary shaft 86, such that the main gear 130 rotates with the secondary shaft 86. For example, as illustrated in FIG. 7, the main gear 130 may be coupled to the secondary shaft 86 with a splined connection. Other examples include other ways of coupling the main gear 130 to the secondary shaft 86 (e.g., with fasteners, clamps, etc.). In some examples, the main gear 130 is integrally formed as a single piece with the secondary shaft 86.

The main gear 130 may include teeth 134 that project radially outwardly. As illustrated in FIG. 3, the main gear 130 may have an overall outer diameter D3, defined by the teeth 134. While a particular number and/or shape of teeth 134 are illustrated in the figures, the main gear 130 may have other numbers and/or shapes of teeth 134 than those illustrated. Additionally, the main gear 130 may have a diameter D3 other than that illustrated.

In the illustrated example, the diameter D3 of the main gear 130 is larger than both the diameter D1 of the drive gear 74 and the diameter D2 of the first driven gear 94, and the number of teeth 134 on the main gear 130 is greater than the number of teeth 78 on the drive gear 74 and the number of teeth 98 on the first driven gear 94.

With reference to FIGS. 2 and 3, in some examples the main gear 130 may be positioned outside of the interior cavity 82 of the bottom bracket 42 and may be partially or entirely exposed and visible from outside of the bicycle 10. In other examples, at least a portion of the main gear 130 may be positioned within the interior cavity 82, and/or be partially or entirely enclosed within the interior cavity 82.

As illustrated in FIGS. 1, 2, and 10, and as described further herein, the main gear 130 may drive a primary chain 136. For example, the primary chain 136 may be a roller chain configured to interface with the main gear 130 and/or a second driven gear 170 as described in further detail below. In other embodiments, the primary chain 136 can be implemented as a belt rather than a chain.

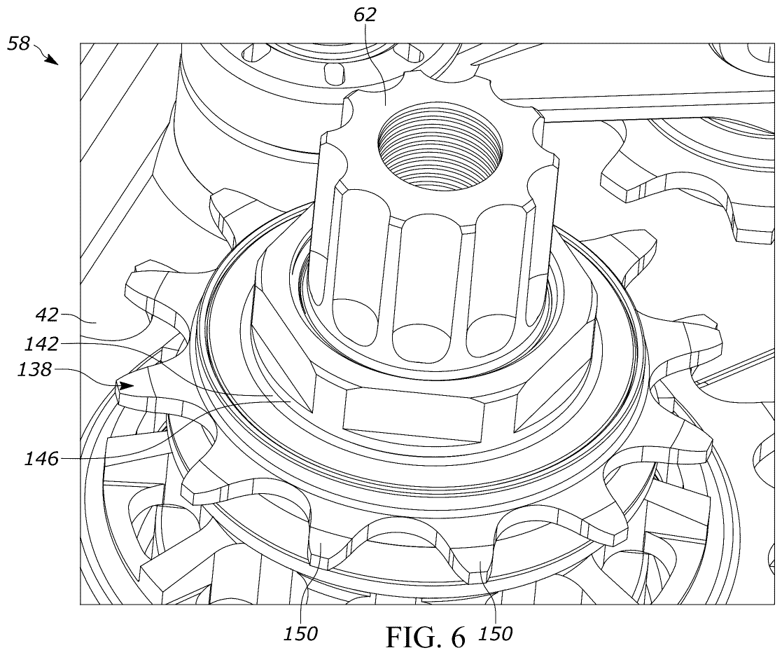

With reference to FIGS. 2-4, 6, and 9, the drivetrain 58 may include an idler 138. In the illustrated example, the idler 138 is rotatable about the spindle 62 and spindle axis 66 independently of a position of the spindle 62 and independently of a position of the crank arm or arms 70. The idler 138 may be concentric with the spindle axis 66. As illustrated in FIG. 6, the idler 138 may include an inner bearing 142 that facilitates rotation of the idler 138 about the spindle 62. The inner bearing 142 may be formed separately from the rest of the idler 138, or integrally formed as a single piece with the rest of the idler 138 (e.g., through co-molding). In some examples, the inner bearing 142 may include a ball bearing, lubricated bearing, or other type of bearing or bearing surface. In some examples, and as seen in FIGS. 5 and 6, the spindle 62 may include an annular outer surface 146. The inner bearing 142 may contact, rotate, or slide around this annular outer surface 146 (e.g., with limited frictional resistance), allowing the idler 138 to rotate about the spindle axis 66.

The idler 138 may include teeth 150 that project radially outwardly. As illustrated in FIG. 3, the idler 138 may have an overall outer diameter D4, defined by the teeth 150. While a particular number and/or shape of teeth 150 are illustrated in the figures, the idler 138 may have other numbers and/or shapes of teeth 150 than those illustrated. Additionally, the idler 138 may have a diameter D4 other than that illustrated.

In the illustrated example, the diameter D4 of the idler 138 is smaller than the diameter D1 of the drive gear 74, and the number of teeth 150 on the idler 138 is less than the number of teeth 78 on the drive gear 74.

With reference to FIG. 3, in some examples the idler 138 may be positioned outside of the interior cavity 82 of the bottom bracket 42 and may be partially or entirely exposed and visible from outside of the bicycle 10. In other examples, at least a portion of the idler 138 may be positioned within the interior cavity 82 and/or be partially or entirely enclosed within the interior cavity 82.

With reference to FIG. 10, and as described above, the drivetrain 58 may include a secondary chain 80 and a primary chain 136. The secondary chain 80 and the primary chain 136 may be selectively engaged by one or more of the gears, idler, and/or tensioner described above. Overall, the secondary chain 80 and the primary chain 136 may be used, for example, to provide power to at least one wheel (e.g., the rear wheel 22) of the bicycle 10, and to propel the bicycle 10 in at least one direction (e.g., forward).

For example, and with continued reference to FIG. 10, the primary chain 136 may form a closed loop having a first inner periphery 154 and a first outer periphery 158. The primary chain 136 may be engaged by each of the idler 138 and the main gear 130. The idler 138 may engage the first outer periphery 158 of the primary chain 136 (e.g., via the teeth 150 on the idler 138), and the main gear 130 may engage the first inner periphery 154 of the primary chain 136 (e.g., via the teeth 134 of the main gear 130).

The primary chain 136 may further extend around and be engaged with a second driven gear 170 (e.g., located at the rear wheel 22, and illustrated schematically in FIGS. 1 and 10). In some examples, the driven gear 170 is concentric with a rear axle 172. In some examples, the primary chain 136 may also be engaged with a derailleur 174 (e.g., a rear derailleur, illustrated as derailleur pulleys in FIGS. 1 and 10). In the illustrated example, the second driven gear 170 is engaged with the first inner periphery 154 of the primary chain 136, and the derailleur pulleys 174 are engaged with the first inner periphery 154 and the first outer periphery 158 of the primary chain 136, respectively.

With continued reference to FIG. 10, the secondary chain 80 may form a closed loop having a second inner periphery 178 and a second outer periphery 182. The secondary chain 80 may be engaged by each of the drive gear 74 and the first driven gear 94 (and also by the pulley 118 of the tensioner 102 in examples that include the tensioner 102). The drive gear 74 may engage the second inner periphery 178 of the secondary chain 80 (e.g., via the teeth 78 of the drive gear 74), and the first driven gear 94 may also engage the second inner periphery 178 of the secondary chain 80 (e.g., via the teeth 98 of the first driven gear 94). The tensioner 102 may engage the second outer periphery 182 of the secondary chain 80 (e.g., via the teeth 122), to maintain tension on the secondary chain 80.

As explained in more detail below, implementing bicycle 10 and/or drivetrain 58 can advantageously provide various performance benefits (e.g., increased kinematic efficiency of the overall drivetrain 58, and/or more control over a rear axle path, pedal kickback, and/or anti-squat), and/or maintenance benefits (e.g., reduced overall wear on components of the drivetrain 58), such as, for example, by permitting for a more rearward axle path of the rear axle 172, greater kinematic efficiency of the primary chain 136, and/or decreased degradation of drivetrain 58 (e.g., primary chain 136).

In many examples, a layout (e.g., position, orientation) of a bicycle chain and/or a path of a rear axle of a bicycle may impact the performance of the bicycle. For example, a more rearward axle path of a rear axle of a bicycle may provide greater stability and control than a more forward axle path. Also, configuring a bicycle chain of a bicycle to be more parallel with a median plane of the bicycle, and/or so that the front gears of the bicycle are better aligned with the rear gears of the bicycle can increase kinematic efficiency of the bicycle chain and/or decrease degradation on the bicycle chain and/or drivetrain of the bicycle.

In some examples, the use of multiple separate chains 80, 136 may provide performance benefits (e.g., increased kinematic efficiency of the overall drivetrain 58, and/or more control over a rear axle path, pedal kickback, and/or anti-squat), and/or maintenance benefits (e.g., reduced overall wear on components of the drivetrain 58). For example, using multiple chains 80, 136 may provide more control over the relative positions of the main gear 130 and the driven gear 170, thereby permitting for more kinematically efficient and/or lower wear layouts of the primary chain 136 Additionally, in some examples, the use of the tensioner 102 may help to maintain more consistent tension on the secondary chain 80, even after wear occurs on the drive gear 74 and/or the first driven gear 94.

In some examples, positioning the idler 138 to engage the first outer periphery 158 of the closed-loop primary chain 136 may act to improve chain wrap on the main gear 130 and inhibit chain drop/drag. The idler 138 may effectively hold up the primary chain 136 from beneath, and/or increase ground clearance of the primary chain 136, and/or keep the primary chain 136 moving in a tightened pathway. Positioning the idler 138 to engage the first outer periphery 158 of the primary chain 136 may also provide performance benefits (e.g., increased kinematic efficiency of the overall drivetrain 58, and/or more control over a rear axle path, pedal kickback, and/or anti-squat), and/or maintenance benefits (e.g., reduced overall wear on components of the drivetrain 58). In some examples, the idler 138 may reduce an amount of chain growth as a rear suspension of the bicycle 10 moves.

As described above, in some examples the idler 138 may be concentric with the spindle axis 66. Positioning the idler 138 to be concentric with the spindle axis 66 rather than at another location of the bicycle 10 (e.g., at another location of the bottom bracket 42 or the drive-side chainstay of the chainstay(s) 54) may provide more room for the chainstay(s) 54 (e.g., inhibiting or preventing the chainstay(s) 54 from rubbing or otherwise contacting the primary chain 136). In these or other examples, this positioning of the idler 138 may facilitate a desired (e.g., greater) distance between an upper chain path (e.g., a portion of the primary chain 136 between the main gear 130 and the driven gear 170) and a lower chain path (e.g., a portion of the primary chain 136 between the main gear 130 and the derailleur pulley(s) 174). In further examples, this positioning of the idler 138 may additionally, or alternatively, permit for more kinematically efficient and/or lower maintenance layouts of the primary chain 136 for a greater range of axle paths options of the rear axle 172.

Some of the examples may be further described by reference to the following numbered clauses:
1. A drivetrain for a bicycle, the drivetrain comprising:
   a spindle;
   a chain forming a closed loop and having an inner periphery and an outer periphery; and
   an idler rotatable around the spindle, wherein the idler is engaged with the outer periphery of the chain.
2. The drivetrain of clause 1, wherein the spindle is a bottom bracket spindle rotatable about a spindle axis, wherein the drivetrain includes a crank arm coupled to the spindle to facilitate rotation of the spindle about the spindle axis, and wherein the idler is rotatable about the spindle axis independently of a position of the crank arm.
3. The drivetrain of any of the preceding clauses, wherein the idler includes an inner bearing configured to facilitate rotation of the idler about the spindle.
4. The drivetrain of any of the preceding clauses, wherein the idler includes a plurality of teeth configured to engage the outer periphery of the chain.
5. The drivetrain of any of the preceding clauses, further comprising a drive gear coupled to the spindle and rotatable with the spindle.
6. The drivetrain of clause 5, wherein the idler includes a first diameter and a first number of gear teeth and the drive gear includes a second diameter and a second number of gear teeth, wherein the second diameter is larger than the first diameter, and the second number of gear teeth is larger than the first number of gear teeth.
7. The drivetrain of clause 5 or clause 6, wherein the drive gear is axially spaced from the idler.
8. The drivetrain of any of clauses 5-7, further comprising a secondary shaft, and a main gear coupled to the secondary shaft, wherein the inner periphery of the chain is engaged with the main gear.
9. The drivetrain of clause 8, wherein the spindle is configured to rotate about a spindle axis, and the secondary shaft is configured to rotate about a secondary shaft axis, wherein the spindle axis is parallel to the secondary shaft axis.
10. The drivetrain of clause 8 or clause 9, further comprising a driven gear coupled to the secondary shaft.
11. The drivetrain of clause 10, wherein the chain is a primary chain, wherein the drivetrain includes a secondary chain engaged with both the drive gear and the driven gear.
12. The drivetrain of clause 11, wherein the driven gear is a first driven gear, wherein the drivetrain further includes a second driven gear at a rear axle of the bicycle, wherein the inner periphery of the primary chain is engaged with the second driven gear.
13. The drivetrain of clause 11 or clause 12, wherein the secondary chain is positioned inboard of the primary chain.
14. The drivetrain of any of clauses 11-13, wherein the closed loop is a first closed loop, wherein the inner periphery is a first inner periphery, and wherein the outer periphery is a first outer periphery, wherein the secondary chain forms a second closed loop having a second inner periphery and a second outer periphery, wherein the drive gear is engaged with the second inner periphery of the secondary chain, and wherein the driven gear is engaged with the second inner periphery of the secondary chain.
15. The drivetrain of clause 14, further comprising a tensioner engaged with the second outer periphery of the secondary chain.
16. The drivetrain of clause 15, wherein the tensioner includes an arm, a pulley at an end of the arm having teeth engaged with the second outer periphery of the secondary chain, and a spring coupled to the arm, wherein the spring biases the pulley toward the secondary chain.
17. A bicycle comprising:
   a front wheel;
   a rear wheel;
   a frame supporting the front wheel and the rear wheel; and
   the drivetrain of claim 1 coupled to the frame.
18. The bicycle of clause 17, wherein the bicycle is an electric bicycle including an electric motor and a battery.
19. The bicycle of clause 17 or clause 18, further comprising a driven gear at the rear wheel, and a derailleur, wherein the inner periphery of the chain is engaged with both the driven gear and the derailleur.
20. The bicycle of any of clauses 17-19, wherein the chain is a primary chain, and further comprising a secondary chain positioned inboard of the primary chain, and a drive gear coupled to the spindle, wherein the secondary chain is engaged with the drive gear.

Various features and advantages of the disclosure are set forth in the following claims.

1. A drivetrain for a bicycle, the drivetrain comprising:
a spindle;
a chain forming a closed loop and having an inner periphery and an outer periphery; and
an idler rotatable around the spindle, wherein the idler is engaged with the outer periphery of the chain.

2. The drivetrain of claim 1, wherein the spindle is a bottom bracket spindle rotatable about a spindle axis, wherein the drivetrain includes a crank arm coupled to the spindle to facilitate rotation of the spindle about the spindle axis, and wherein the idler is rotatable about the spindle axis independently of a position of the crank arm.

3. The drivetrain of claim 1, wherein the idler includes an inner bearing configured to facilitate rotation of the idler about the spindle.

4. The drivetrain of claim 1, wherein the idler includes a plurality of teeth configured to engage the outer periphery of the chain.

5. The drivetrain of claim 1, further comprising a drive gear coupled to the spindle and rotatable with the spindle.

6. The drivetrain of claim 5, wherein the idler includes a first diameter and a first number of gear teeth and the drive gear includes a second diameter and a second number of gear teeth, wherein the second diameter is larger than the first diameter, and the second number of gear teeth is larger than the first number of gear teeth.

7. The drivetrain of claim 5, wherein the drive gear is axially spaced from the idler.

8. The drivetrain of claim 5, further comprising a secondary shaft, and a main gear coupled to the secondary shaft, wherein the inner periphery of the chain is engaged with the main gear.

9. The drivetrain of claim 8, wherein the spindle is configured to rotate about a spindle axis, and the secondary shaft is configured to rotate about a secondary shaft axis, wherein the spindle axis is parallel to the secondary shaft axis.

10. The drivetrain of claim 8, further comprising a driven gear coupled to the secondary shaft.

11. The drivetrain of claim 10, wherein the chain is a primary chain, wherein the drivetrain includes a secondary chain engaged with both the drive gear and the driven gear.

12. The drivetrain of claim 11, wherein the driven gear is a first driven gear, wherein the drivetrain further includes a second driven gear at a rear axle of the bicycle, wherein the inner periphery of the primary chain is engaged with the second driven gear.

13. The drivetrain of claim 11, wherein the secondary chain is positioned inboard of the primary chain.

14. The drivetrain of claim 11, wherein the closed loop is a first closed loop, wherein the inner periphery is a first inner periphery, and wherein the outer periphery is a first outer periphery, wherein the secondary chain forms a second closed loop having a second inner periphery and a second outer periphery, wherein the drive gear is engaged with the second inner periphery of the secondary chain, and wherein the driven gear is engaged with the second inner periphery of the secondary chain.

15. The drivetrain of claim 14, further comprising a tensioner engaged with the second outer periphery of the secondary chain.

16. The drivetrain of claim 15, wherein the tensioner includes an arm, a pulley at an end of the arm having teeth engaged with the second outer periphery of the secondary chain, and a spring coupled to the arm, wherein the spring biases the pulley toward the secondary chain.

17. A bicycle comprising:
a front wheel;
a rear wheel;
a frame supporting the front wheel and the rear wheel; and
the drivetrain of claim 1 coupled to the frame.

18. The bicycle of claim 17, wherein the bicycle is an electric bicycle including an electric motor and a battery.

19. The bicycle of claim 17, further comprising a driven gear at the rear wheel, and a derailleur, wherein the inner periphery of the chain is engaged with both the driven gear and the derailleur.

20. The bicycle of claim 17, wherein the chain is a primary chain, and further comprising a secondary chain positioned inboard of the primary chain, and a drive gear coupled to the spindle, wherein the secondary chain is engaged with the drive gear.
